(19) United States
(12) Patent Application Publication
(10) Pub. No.: US 2013/0010913 A1
(43) Pub. Date: Jan. 10, 2013

(54) NUCLEAR FUEL ASSEMBLY POSITIONING SYSTEM HAVING BUILT-IN SOLENOID VALVE BOX

(76) Inventors: Jung Cheol Shin, Daejeon (KR); Sang Kyun Woo, Daejeon (KR); Je Seong You, Daejeon (KR); Jung Ho Song, Daejeon (KR); Seung Won Suh, Daejeon (KR)

(21) Appl. No.: 13/313,893

(22) Filed: Dec. 7, 2011

(30) Foreign Application Priority Data
Jul. 8, 2011 (KR) 10-2011-0067725

(51) Int. Cl. G21C 19/12

(52) U.S. Cl. 376/261

(57) ABSTRACT

Provided is a nuclear fuel assembly positioning system having a built-in solenoid valve box in an apparatus for testing nuclear fuel used in an atomic power plant. A work table is installed at a predetermined position within an underwater fuel storage pool, and a solenoid valve box connected to two pneumatic hoses extending from the outside is integrally installed on an test table so as to drive the test table, so that only the two pneumatic hoses simplified as a gas supply hose and a gas discharge hose are connected with the test table, and thus the nuclear fuel assembly is accurately and rapidly positioned as to be able to conveniently perform testing without the structures around the hoses being interfered with when pneumatic motors are operated.

### CROSS-REFERENCE TO RELATED APPLICATIONS

The present application claims priority under 35 U.S.C. 119 to Korean Patent Application No. 10-2011-0067725, filed on Jul. 8, 2011, the disclosure of which is expressly incorporated by reference herein in its entirety.

### BACKGROUND OF THE INVENTION

1. Field of the Invention

The present invention relates, in general, to a nuclear fuel assembly positioning system having a built-in solenoid valve box and, more particularly, to a nuclear fuel assembly positioning system having a solenoid valve box built into an apparatus for testing nuclear fuel used in an atomic power plant, in which a work table is installed at a predetermined position within an underwater fuel storage pool, and in which the solenoid valve box connected to two pneumatic hoses extending from the outside is integrally installed on the work table so as to drive a test table, so that only the two pneumatic hoses of a gas supply hose and a gas discharge hose are used in the positioning system, and thus the nuclear fuel assembly is accurately and rapidly positioned as to be able to perform testing conveniently without interfering with structures around the hoses when pneumatic motors are operated.

2. Description of the Related Art

Generally, nuclear reactors generating nuclear energy using nuclear fuel require high reliability. Thus, it is very important in the nuclear reactors to test specifications, structural deformation, variations in material characteristics, and etc., of the nuclear fuel.

As for the nuclear fuel, the nuclear fuel is charged into and protected by a pipe, so that a fuel rod is made. A predetermined number of fuel rods are packed into a bundle. The nuclear fuel is transferred into a nuclear reactor in the unit of a bundle.

The nuclear fuel bundle, also called a nuclear fuel assembly, combined in a bundle is transferred to and stored at a predetermined area within an underwater fuel storage pool by a fuel handling crane.

Examples of the related art include Korean Patent No. 10-0627129, entitled “Atomic reactor nuclear fuel control unit inspection apparatus,” Korean Patent No. 10-0431721, entitled “Inspection device,” Korean Patent Application Publication No. 10-2001-0029780, entitled “Fuel assembly mechanical flow restriction apparatus for detecting failure in-situ of nuclear fuel rods in a fuel assembly during reactor shutdown,” and so forth.

To test the performance of the fuel rods, the nuclear fuel has been tested using nuclear fuel test equipment 10 as shown in FIG. 1.

Such nuclear fuel test equipment 10 includes three pneumatic motors for underwater testing. Each pneumatic motor is connected to three hoses (for forward rotation, backward rotation, and air-pressure release) having a length of about 30 meters. Thus, a total of nine hoses 20 are connected with the three pneumatic motors of the test equipment 10. As such, interference occurs whenever the pneumatic motors are driven, so that many difficulties are encountered when performing the work of testing.

In detail, when the test equipment connected with the numerous hoses 20 tests the nuclear fuel, the numerous hoses 20 interfere with the test operation. This creates the possibility of damage being done to the test equipment or the nuclear fuel assembly as well as the impossibility of accurately and rapidly moving to a test position.

Accordingly, the work of testing is very inconvenient and time-consuming, and is accompanied by safety problems and the problem that uniform tests cannot be conducted.

### SUMMARY OF THE INVENTION

Accordingly, the present invention has been made keeping in mind the above problems occurring in the related art, and the present invention is intended to provide a nuclear fuel assembly positioning system having a built-in solenoid valve box in an apparatus for testing nuclear fuel used in an atomic power plant, in which a work table is installed at a predetermined position within an underwater fuel storage pool, and in which the solenoid valve box connected to two pneumatic hoses extending from the outside is integrally installed on an the work table so as to drive a test table, so that only the two pneumatic hoses of a gas supply hose and a gas discharge hose are used in the positioning system, and thus the nuclear fuel assembly is accurately and rapidly positioned as to be able to perform testing conveniently without interfering with their surrounding structures to the minimum extent possible when the pneumatic motors are operated.

In order to achieve the objective of the invention, according to one embodiment of the present invention, there is provided a nuclear fuel assembly positioning system having a built-in solenoid valve box, which comprises: a work table having a stage; a test table mounted on the work table and configured to move in x-, y- and z-axial directions by the operation of respective pneumatic motors so as to test a nuclear fuel assembly; and a solenoid valve box installed under the test table in a rectangular box shape, to which two pneumatic hoses are connected on one side thereof, and in which a variety of control means, such as solenoids and automatic controllers are mounted.

Here, the work table can be installed in an underwater fuel storage pool.

Further, the simplified two pneumatic hoses connected to the solenoid valve box can be prevented from interfering with x-, y- and z-axial transfer tables that are in operation when the nuclear fuel assembly is tested on the test table.

In addition, the solenoid valve box is mounted on one side of a lower portion of the test table so as to be integrated with the test table.

According to the present invention as described above, the two pneumatic hoses are connected to the solenoid valve box installed under the test table for testing the nuclear fuel, so that, when the pneumatic motors are driven, it is possible to minimize interference between the hoses and the test table, to simplify the apparatus, and to accurately and rapidly position the nuclear fuel assembly so as to conveniently perform testing.

Further, the nuclear fuel assembly positioning system can accurately and rapidly position the nuclear fuel assembly under water.

### BRIEF DESCRIPTION OF THE DRAWINGS

The above and other objects, features and further advantages of the present invention will be more clearly understood from the following detailed description when taken in conjunction with the accompanying drawings, in which:

FIG. 1 is a perspective view showing a conventional nuclear fuel assembly testing apparatus;

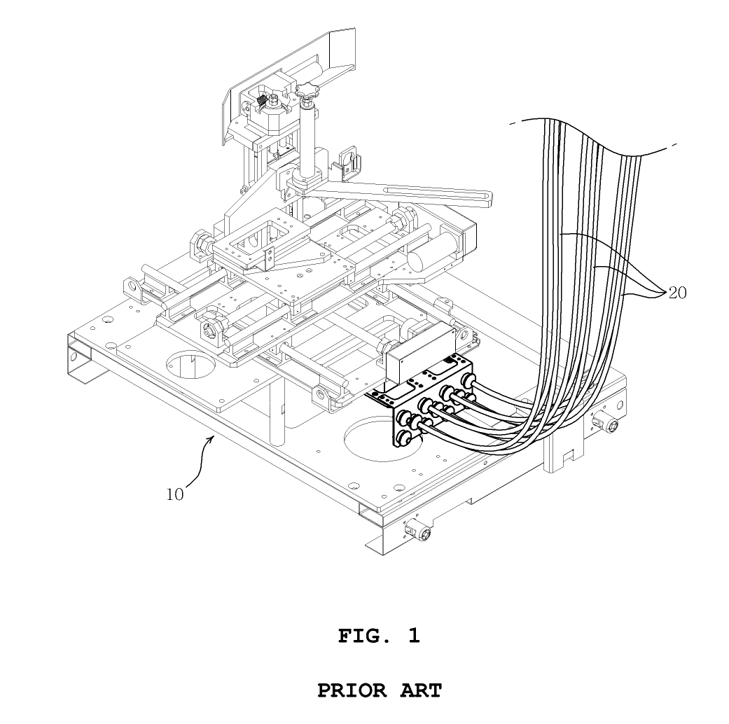

FIG. 2 is a perspective view showing a nuclear fuel assembly positioning system having a built-in solenoid valve box according to an exemplary embodiment of the present invention;

FIG. 3 is a side view showing the nuclear fuel assembly positioning system having a built-in solenoid valve box according to the exemplary embodiment of the present invention;

FIG. 4 is a perspective view showing a solenoid valve box mounted in the nuclear fuel assembly positioning system according to the exemplary embodiment of the present invention; and

FIG. 5 is a perspective view showing an internal structure of the solenoid valve box mounted in the nuclear fuel assembly positioning system according to the exemplary embodiment of the present invention.

### DETAILED DESCRIPTION OF THE INVENTION

In order to achieve the above objective, the present invention is directed to providing a nuclear fuel assembly positioning system having a built-in solenoid valve box, the nuclear fuel assembly positioning system comprises:

a work table having a stage;

a test table mounted on the work table and configured to move in x-, y- and z-axial directions by the operation of respective pneumatic motors so as to test a nuclear fuel assembly; and

a solenoid valve box which is installed under the test table in a rectangular box shape, to which two pneumatic hoses are connected on one side thereof, and in which a variety of control means, such as solenoids and automatic controllers are mounted.

Reference will now be made in greater detail to exemplary embodiments of the invention with reference to the accompanying drawings.

The terms or words used in the specification and claims are not to be interpreted by their typical or dictionary meanings but their meanings and concepts should be construed in conformity with the technical idea of the invention, based on the principle that the inventor can properly define the concepts of the terms so as to explain the invention in the best manner.

Accordingly, the embodiments described in the specification and the configurations shown in the drawings are only one exemplary example of the invention, and do not represent the entire technical idea of the invention. Therefore, it should be understood that a variety of equivalents and modifications capable of substituting for the embodiments and configurations at the time of filing the patent application of the invention can be made.

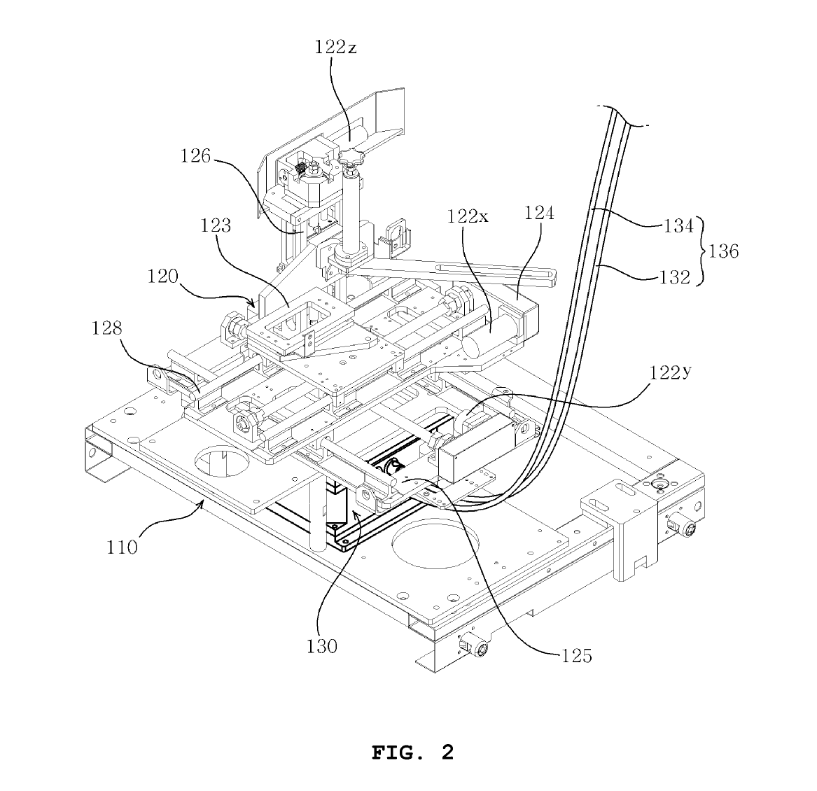

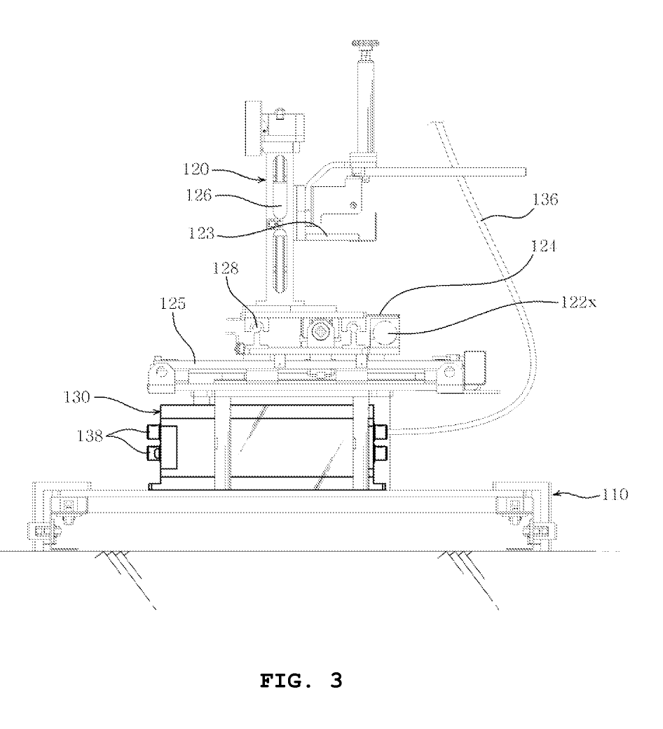

FIG. 2 is a perspective view showing a nuclear fuel assembly positioning system having a built-in solenoid valve box according to an exemplary embodiment of the present invention, and FIG. 3 is a side view showing the nuclear fuel assembly positioning system having a built-in solenoid valve box according to the exemplary embodiment of the present invention.

As shown, an apparatus for testing nuclear fuel used in an atomic power plant in accordance with an exemplary embodiment of the present invention is configured to accurately and rapidly position a nuclear fuel assembly so as to be able to conveniently make a test. To this end, a work table 110 is installed at a predetermined position within an underwater fuel storage pool (not shown), and a solenoid valve box 130 connected to two pneumatic hoses 136 extending from the outside is mounted under an test table 120 so as to drive the test table 120 in X-, Y-, and Z-axial directions. Thereby, only the two pneumatic hoses having a gas supply hose 132 and a gas discharge hose 134 are connected with the solenoid valve box 130, and thus interference between the hoses and the test table is minimized when pneumatic motors 122x, 122y and 122z are operated.

This test table 120 for testing the performance of the nuclear fuel assembly (not shown) is used in light water reactors.

In the testing apparatus that is also used to precisely measure and test specifications of the nuclear fuel assembly, the work table 110 is placed at a predetermined position within the underwater fuel storage pool.

In the testing apparatus capable of testing the nuclear fuel assembly, the work table 110 is provided with a stage for mounting the test table 120 for testing performance of the nuclear fuel assembly.

A variety of measuring instruments are installed on the work table 110, on which a variety testing operations, such as the burn performance of the nuclear fuel assembly, are conducted.

The test table 120 is mounted on the work table 110 so as to directly test the nuclear fuel assembly. The test table 120 includes a plotter table 123 that directly displaces the nuclear fuel assembly, an x-axial transfer table 124, a y-axial transfer table 125, and a z-axial transfer table 126, all of which are controlled by a solenoid valve box 130. The solenoid valve box 130 is disposed in a space between the work table 110 and the test table 120.

First, the test table 120 mounted on the work table 110 is configured to test the nuclear fuel assembly. To this end, the plotter table 123 and the x-, y- and z-axial transfer tables 124, 125 and 126 are configured to move in x-, y- and z-axial directions and are driven by respective pneumatic motors 122x, 122y and 122z.

The plotter table 123 is a member that is assembled to the z-axial transfer table 126 and is used to displace the nuclear fuel assembly.

The x-axial transfer table 124 is configured to transfer the plotter table 123 for displacing the nuclear fuel assembly along a guide 128 in forward and backward directions.

The x-axial transfer table 124 is connected to the pneumatic motor 122x, and is driven by the supply of gas.

The y-axial transfer table 125 is installed under the x-axial transfer table 124 so that the plotter table 123 and the x-axial transfer table 124 of the test table 120 can move in left and right directions.

The y-axial transfer table 125 is connected to the pneumatic motor 122y, and is driven by the supply of gas.

The z-axial transfer table 126 assembled for the test table 120 is configured to move the plotter table 123 up or down.

Further, to control the x-, y- and z-axial transfer tables 124, 125 and 126 configured to move in x-, y- and z-axial directions for the test table 120, each of the pneumatic motors 122x, 122y and 122z are installed per axis, and the solenoid valve box 130 is configured to control the pneumatic motors 122x, 122y and 122z.

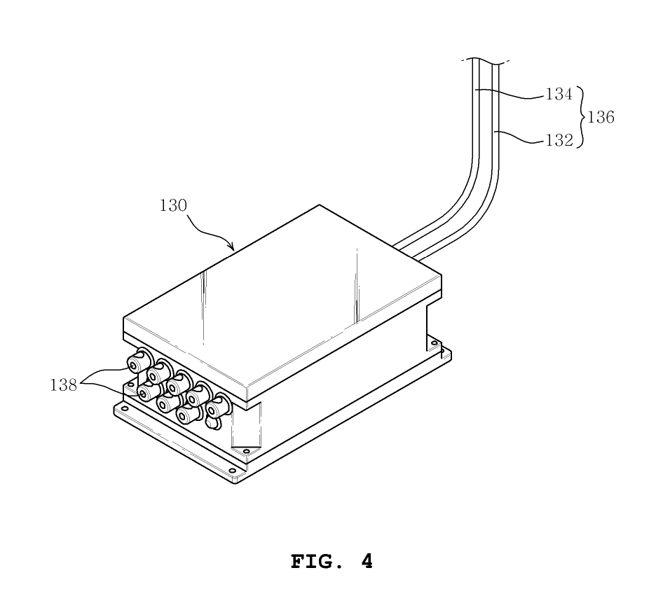

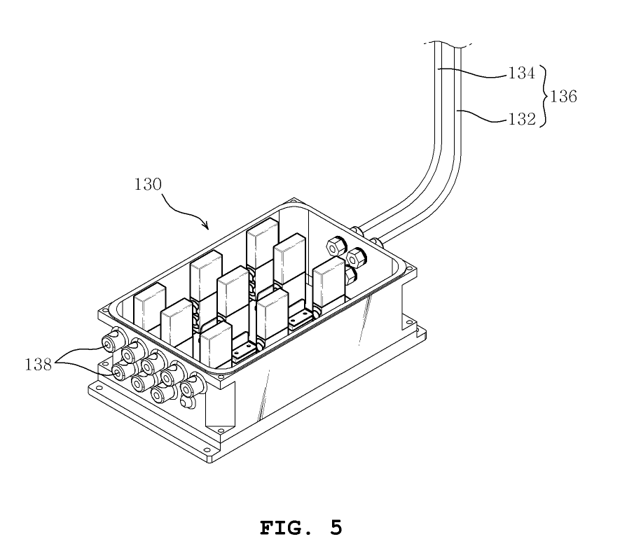

Here, as shown in FIGS. 4 and 5, the solenoid valve box 130 is installed on the work table 110 in a rectangular box shape, and is configured so that two pneumatic hoses 136 having a gas supply hose 132 and a gas discharge hose 134 are connected to one side thereof and so that a variety of control means such as solenoids and automatic controllers are mounted therein.

That is, the two pneumatic hoses 136 connected to the solenoid valve box 130 are put from the outside into water, and are connected to the solenoid valve box 130. When the nuclear fuel assembly is tested on the test table 120, the two pneumatic hoses 136 drive the x-, y- and z-axial transfer tables 124, 125 and 126.

Here, since only the two pneumatic hoses 136 are used to test the nuclear fuel assembly on the test table 120, interference with the x-, y- and z-axial transfer tables 124, 125 and 126 that are in operation is minimized.

To sum up, the two pneumatic hoses 136 configured of the gas supply hose 132 and the gas discharge hose 134 are connected to one side of the solenoid valve box 130 so as to supply gas from the outside.

The solenoid valve box 130 is provided with a plurality of connector pipes 138 on the other side thereof which supply the gas supplied through the two pneumatic hoses 136 to the pneumatic motors 122x, 122y and 122z again. The connector pipes 138 are connected to valves assembled with the respective pneumatic motors 122x, 122y and 122z.

As described above, the two pneumatic hoses 136 for introducing the gas from the outside are connected to one side of the solenoid valve box 130, and the plurality of connector pipes 138 for supplying the gas to the respective pneumatic motors 122x, 122y and 122z are connected with valves (not shown) which are provided to control the gas to the motors. Thereby, the x-, y- and z-axial transfer tables 124, 125 and 126 are controlled to move in the x-, y- and z-axial directions.

In this manner, the simplification into the two pneumatic hoses 136 connected from the outside allows the interference in the movements of the x-, y- and z-axial transfer tables 124, 125 and 126 to be minimized. The numerous valves connected to the other side of the solenoid valve box 130 are driven without impeding the movements of the x-, y- and z-axial transfer tables 124, 125 and 126 within the test table 120.

This solenoid valve box 130 may be mounted on one side of a lower portion of the test table 120, and usefully simplifies a working environment.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A nuclear fuel assembly positioning system having a built-in solenoid valve box for testing a nuclear fuel assembly, the nuclear fuel assembly positioning system comprising:
a work table having a stage;
a test table mounted on the work table and configured to move in x-, y- and z-axial directions by operation of respective pneumatic motors; and
a solenoid valve box installed under the test table in a rectangular box shape;
wherein the solenoid valve box is connected with two pneumatic hoses acting respectively as a gas supply hose and a gas discharge hose; and
wherein the solenoid valve box includes at least one solenoid valve or at least one automatic controller.

2. The nuclear fuel assembly positioning system as set forth in claim 1, wherein the work table is installed in an underwater fuel storage pool.

3. The nuclear fuel assembly positioning system as set forth in claim 1, wherein the two pneumatic hoses connected to the solenoid valve box are configured to prevent interference from the test table.

4. The nuclear fuel assembly positioning system as set forth in claim 1, wherein the solenoid valve box includes a plurality of connector pipes on one side thereof, and
wherein the plurality of connector pipes are connected to the respective pneumatic motors which are configured to drive the respective transfer tables.

5. The nuclear fuel assembly positioning system as set forth in claim 1, wherein the solenoid valve box is mounted on one side of a lower portion of the test table.

6. A nuclear fuel assembly positioning system having a built-in solenoid valve box for testing a nuclear fuel assembly, the nuclear fuel assembly positioning system comprising:
a work table having a stage;
a test table mounted on the work table and configured to move in x-, y- and z-axial directions by operation of respective pneumatic motors; and
a solenoid valve box installed under the test table in a rectangular box shape;
wherein the work table is installed in an underwater fuel storage pool,
wherein the solenoid valve box is connected with two pneumatic hoses acting respectively as a gas supply hose and a gas discharge hose; and
wherein the solenoid valve box includes at least one solenoid valve or at least one automatic controller,
wherein the solenoid valve box includes a plurality of connector pipes on one side thereof,
wherein the plurality of connector pipes are connected to the respective pneumatic motors which are configured to drive the respective transfer tables, and
wherein the solenoid valve box is mounted on one side of a lower portion of the test table.
